(19) United States
(12) Patent Application Publication
(10) Pub. No.: US 2016/0033088 A1
(43) Pub. Date: Feb. 4, 2016

(54) LED LIGHT MODULE AND METHOD FOR INSTALLING SAME

(71) Applicant: ABL IP Holding LLC, Conyers, GA (US)

(72) Inventors: John T. Mayfield, III, Loganville, GA (US); Forrest Starnes McCanless, Oxford, GA (US); Stephen Barry McCane, McDonough, GA (US)

(21) Appl. No.: 14/813,464

(22) Filed: Jul. 30, 2015

Related U.S. Application Data
(60) Provisional application No. 62/030,858, filed on Jul. 30, 2014.

(51) Int. Cl. F21K 99/00; F21S 8/04; F21V 19/00; F21V 23/00; F21V 11/06; F21S 8/02; F21V 7/00

(52) U.S. Cl. CPC F21K 9/17; F21S 8/026; F21S 8/046; F21V 7/005; F21V 23/009; F21V 11/06; F21V 19/008; F21K 9/90; F21Y 2103/003

(57) ABSTRACT

A light emitting diode (“LED”) light module that can be installed in lighting fixtures—either new lighting fixtures or existing lighting fixtures already installed in the field. The LED light module includes a LED assembly mounted on a reflector. The LED light module is positioned in a light fixture housing to emit light from the fixture housing.

### CROSS REFERENCE TO RELATED APPLICATIONS

This application claims the benefit of U.S. Provisional Application Ser. No. 62/030,858, filed on Jul. 30, 2014, entitled “Light Assembly for Light Fixture,” the entirety of which is hereby incorporated by this reference.

### FIELD OF THE INVENTION

This invention relates to an LED light module for use in new light fixtures or for retrofitting into existing light fixtures, particularly existing fluorescent light fixtures.

### BACKGROUND

Traditional light fixtures presently used in typical office or commercial environments comprise a troffer with at least one fluorescent lamp to illuminate a space. For many years the most common fluorescent lamps for use in indoor lighting have been the linear T5 (⅝ inch diameter), T8 (1 inch diameter), and the T12 (1½ inch diameter). Such bulbs are inefficient and have a relatively short lamp life. Thus, efforts have been made to identify suitable alternative illumination sources for indoor lighting applications. Light emitting diodes (“LEDs”) have been identified as one alternative to traditional fluorescent bulbs.

An LED typically includes a diode mounted onto a die or chip, where the diode is surrounded by an encapsulant. The die is connected to a power source, which, in turn, transmits power to the diode. An LED used for lighting or illumination converts electrical energy to light in a manner that results in very little radiant energy outside the visible spectrum. LEDs are extremely efficient, and their efficiency is rapidly improving. For example, the lumen output obtained by 20 LEDs may soon be obtained by 10 LEDs.

However, in comparison to simply changing a light bulb in a conventional light fixture, exchanging an existing fluorescent fixture for a light fixture that uses LEDs as a light source can be labor intensive and costly. Such replacement typically requires access to the area above the ceiling. Environmental concerns, such as asbestos contamination and asbestos removal, become an issue when disturbing the ceiling. Moreover, the area above the ceiling collects dirt and dust, which can dislodge during LED replacement and thereby increase the time and cost of clean-up after installation. Additionally, exposed electrical wiring is common in such areas, which creates a safety hazard for workers removing old fixtures. A licensed electrician may be required to install the new fixtures based upon common safety codes. Thus, businesses and consumers are reticent to invest in a new LED light fixture when the effort and costs are compared to maintaining an existing fluorescent light fixture.

Efforts have also been made to retrofit an existing fluorescent light fixture with an LED light source. However, existing fluorescent light fixtures may come in any number of different sizes and configurations. Specifically, LED retrofit kits may not be generally compatible with existing fluorescent light fixtures. Oftentimes, a given LED retrofit kit may only be compatible with existing light fixtures that share a common mounting arrangement. Even if the LED retrofit kit is compatible, it may be difficult to install, particularly for a single worker. Therefore, there exists a need for an LED retrofit kit that is generally compatible with existing light fixtures, and that may be easily installed by a single worker.

### SUMMARY

The terms “invention,” “the invention,” “this invention” and “the present invention” used in this patent are intended to refer broadly to all of the subject matter of this patent and the patent claims below. Statements containing these terms should be understood not to limit the subject matter described herein or to limit the meaning or scope of the patent claims below. Embodiments of the invention covered by this patent are defined by the claims below, not this summary. This summary is a high-level overview of various aspects of the invention and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings and each claim.

Embodiments of the present invention provide a light emitting diode (“LED”) light module that can be installed in lighting fixtures—either new lighting fixtures or existing lighting fixtures already installed in the field. The LED light module includes a LED assembly mounted on a reflector. The LED light module is positioned in a light fixture housing to emit light from the fixture housing.

### BRIEF DESCRIPTION OF THE DRAWINGS

FIG. 1 is a bottom perspective view of a LED light module according to an embodiment of the present invention.

FIG. 2 is a bottom perspective view of one embodiment of a LED assembly for use in the LED light module of FIG. 1.

FIG. 3 is an exploded view of the LED assembly of FIG. 2.

FIG. 4 is cross-sectional view of the LED assembly of FIG. 2.

FIG. 5 is a bottom perspective view of one embodiment of a reflector for use in the LED light module of FIG. 1.

FIG. 6 is a bottom perspective view of two LED light modules of FIG. 1 installed within a fixture housing.

FIG. 7 is a bottom perspective view of an alternative embodiment of a LED light module with an access door.

FIG. 8 is a detail view of the LED light module of FIG. 7.

FIG. 9 is an exploded view of one embodiment of an installation including a housing, mounting brackets, the LED light module of FIG. 7, and a louver.

FIG. 10 is a bottom perspective view of a louvered troffer fixture according to one embodiment.

FIG. 11 is a bottom perspective view of a louvered troffer fixture according to another embodiment.

### DETAILED DESCRIPTION

The subject matter of embodiments of the present invention is described here with specificity to meet statutory requirements, but this description is not necessarily intended to limit the scope of the claims. The claimed subject matter may be embodied in other ways, may include different elements or steps, and may be used in conjunction with other existing or future technologies. This description should not be interpreted as implying any particular order or arrangement among or between various steps or elements except when the order of individual steps or arrangement of elements is explicitly described.

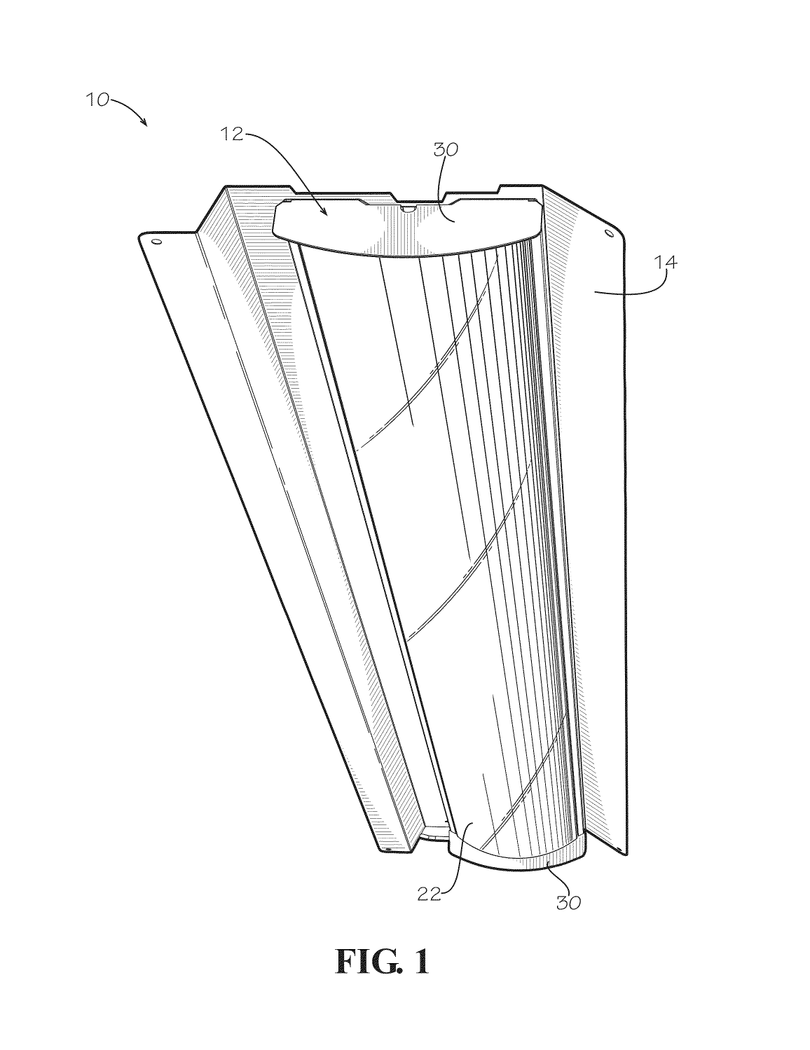

Embodiments of the present invention relate to a light emitting diode (“LED”) light module 10 that can be installed in lighting fixtures—either new lighting fixtures or existing lighting fixtures already installed in the field (e.g., installed to replace the fluorescent light sources in existing fixtures). The LED light module 10 includes (1) a LED assembly 12 mounted on a (2) reflector 14. See FIG. 1. The LED light module 10 is positioned in a troffer (either by itself or with any number of other lighting assemblies) to emit light from the troffer. See FIG. 6. While the LED light module 10 is described and illustrated for use in a recessed troffer fixture, it can be used in other types of fixtures, including, but not limited to, surface mounted and suspended fixtures.

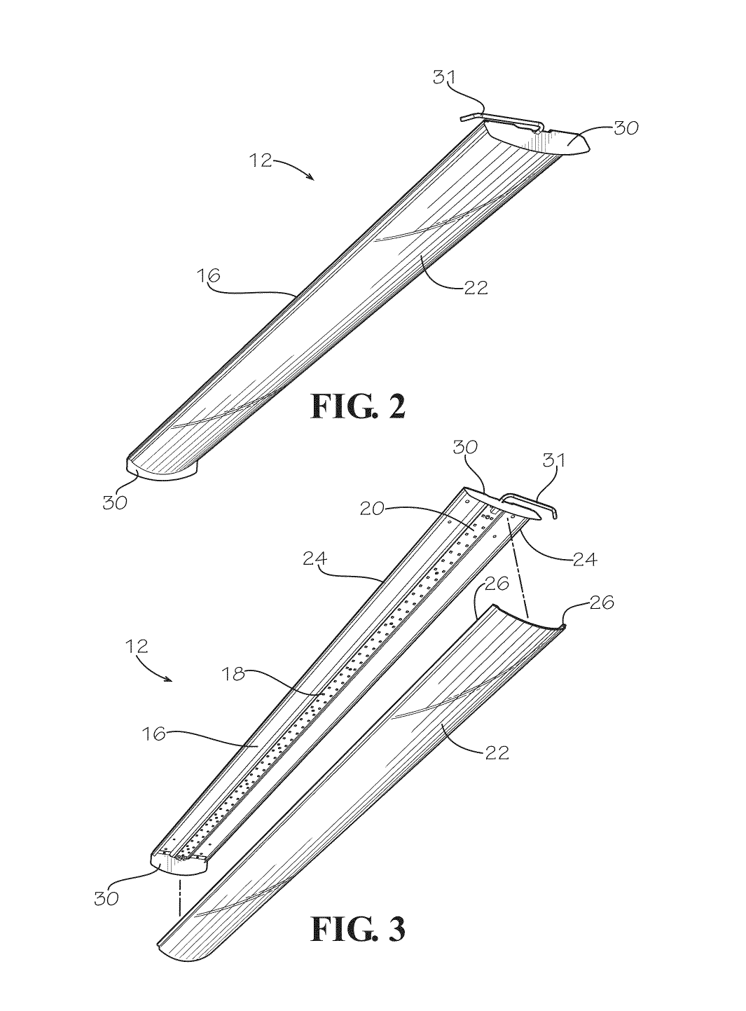

The LED assembly 12 includes a channel 16 onto which LEDs 18 are mounted. See FIGS. 2 and 3. The channel 16 may be substantially planar (although it could be other shapes) and may be formed of any material having the requisite structural integrity and thermal management capabilities so as to conduct heat generated by the LEDs 18. For example, in some embodiments, the channel 16 is formed from metallic materials, such as but not limited to steel, aluminum, etc.

At least one printed circuit board (“PCB”) 20 populated with LEDs 18 is mounted on the channel 16. Each PCB 20 can have wiring for connecting to a power supply, which can be shared between PCBs 20 or each PCB 20 could have its own power supply. The LEDs 18 may be single-die or multi-die LEDs, DC or AC, or can be organic light emitting diodes. White, color, or multicolor LEDs may be used. Moreover, the LEDs 18 mounted on a PCB 20 need not all be the same color; rather, mixtures of LEDs may be used. Furthermore, in some embodiments no PCB is needed; rather, the LEDs 18 are chip-on-board LEDs provided directly on the channel.

An optic 22 is mounted on the channel 16. The optic 22 may serve both as an aesthetic cover and to functionally direct or diffuse light to provide better lighting conditions. The optic 22 may be of any type (diffuse, prismatic, etc.) that achieves the desired light emission from the fixture. While a curved optic is shown, the optic 22 may have any geometry and may be provided with any surface enhancements or no surface enhancements. By way only of example, the optic 22 could have the shape of the optics disclosed in U.S. patent application Ser. No. 14/696,042, filed on Apr. 24, 2015 and entitled “Tri-Lobe Optic and Associated Light Fixtures,” the entirety of which is herein incorporated by reference.

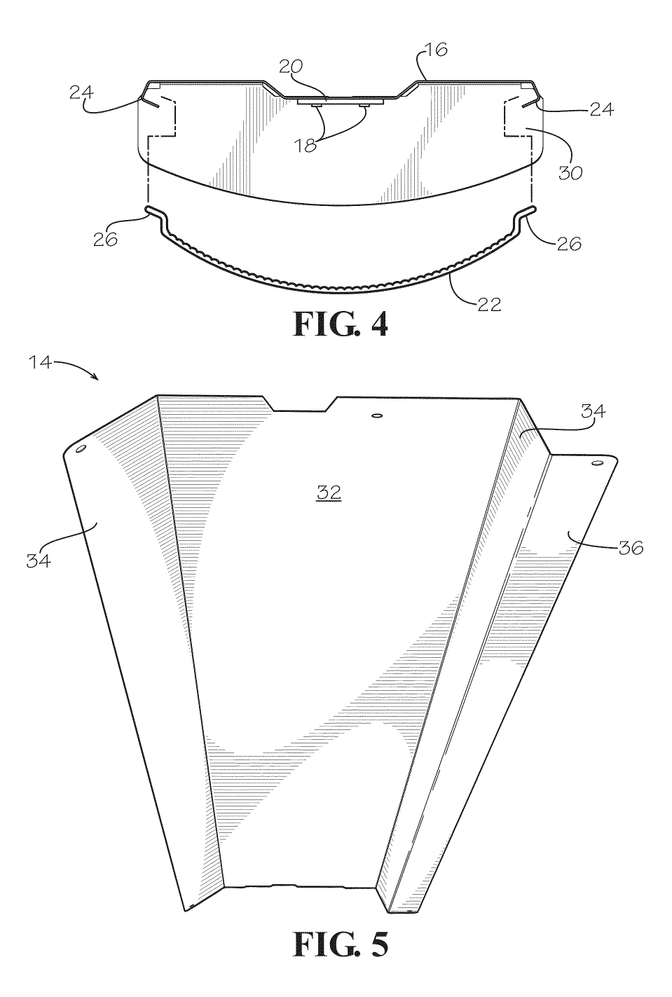

The optic 22 may be affixed or otherwise secured to the channel 16 in any way, including with mechanical fasteners (e.g., screws, self-tapping screws, bolts, pins, rivets, or any other mechanical fastening device). In one embodiment, channel side arms 24 extend downwardly along at least a portion of the length of the channel 16. The opposing edges 26 of the optic 22 are positioned under the channel side arms 24 (such as via snap-fit connection), which thereby serve to retain the optic 22 on the channel 16. See FIG. 4.

End plates 30 (which in some embodiments include a reflective surface) may also be provided on the channel 16 to prevent dark spots from occurring proximate the channel ends as well as to provide a wireway for wiring 31. The channel side arms 24 and end plates 30 may be formed integrally with the channel 16 or may be separately attached thereto.

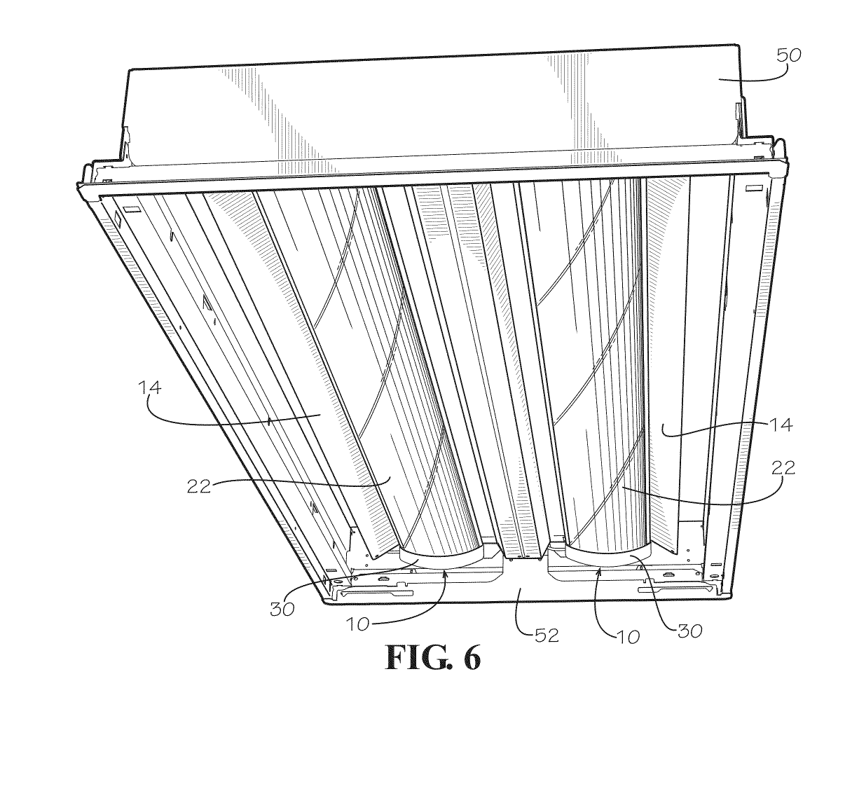

The LED assembly 12 is mounted onto the base 32 of the reflector 14, from which at least one reflective wall 34 extends to reflect light emitted from the LED assembly 12. See FIG. 5. In the illustrated embodiment, the reflector 14 includes two reflective walls 34 that extend downwardly from the reflector base 32. The reflective walls 34 may have any geometry and are not limited to that shown in the attached figures. The reflector 14 may be formed of any material having the requisite structural integrity and thermal management capabilities so as to conduct heat generated by the LED assembly 12. For example, in some embodiments, the reflector 14 is formed from metallic materials, such as but not limited to steel, aluminum, etc.

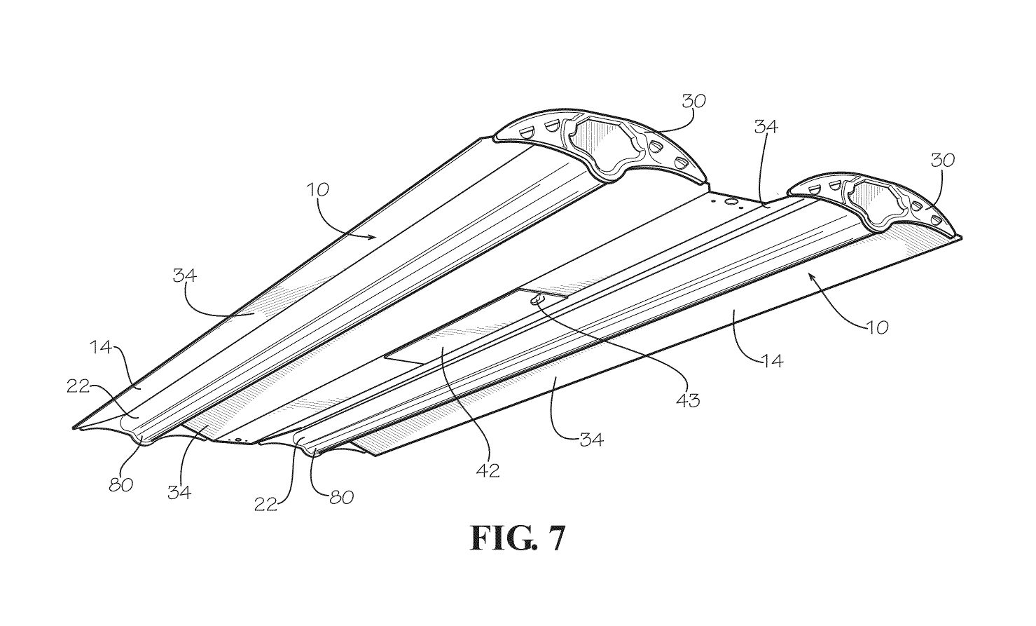

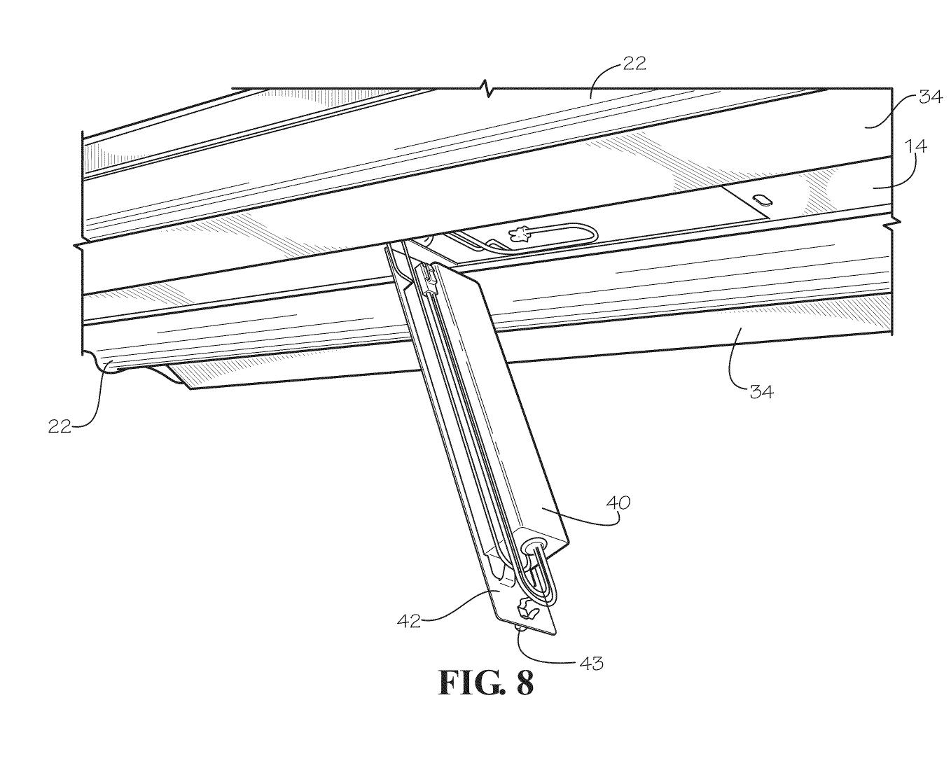

In some embodiments, multiple LED light modules 10 are installed in a light fixture, either end to end or side to side (see FIG. 6). By way only of example, in some embodiments the reflector 14 includes a wing 36 that extends outwardly from at least one of the reflective walls 34. LED light modules 10 may be positioned side to side such that the reflector wings 36 of the LED light modules 10 overlap and can be secured together to retain the LED light modules 10 in the side to side relationship. Alternatively, a single reflector 14 can be formed to have multiple reflector bases 32, onto each of which a LED assembly 12 may be mounted. See FIG. 7. Regardless, in such embodiments the necessary LED light module 10 electronics 40 (e.g., driver(s) for powering the LED assemblies) may be mounted on the back side of the reflector(s) 14. In some embodiments, the electronics 40 are mounted on the back side of an access door 42 provided on the reflector(s) 14. See FIG. 7. One end of the access door 42 is hingedly attached to the reflector 14 and the opposing end removably attached such that access door 42 may swing downwardly from the reflector 14 to permit access to the electronics 40 and associated wiring, as discussed in more detail below. See FIG. 8.

The LED light module 10 is sized to fit within the housing 50 of a light fixture. The LED light module 10 may be formed to fit within specific housing dimensions or it may be provided in a size that generally will fit within most generic existing light fixtures (e.g., it will universally fit with existing fixtures). In the illustrated embodiments discussed below, the LED light module 10 includes two LED assemblies 12 mounted on a reflector 14, which can be formed of two separate reflectors joined together or from a single reflector (as discussed above).

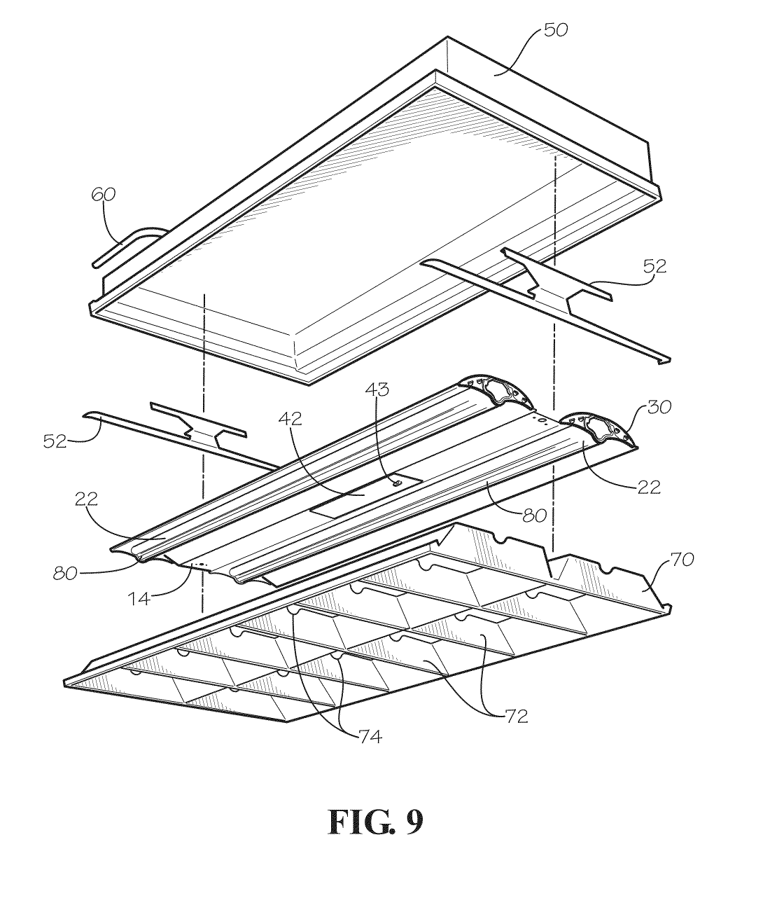

The LED light module 10 may be mounted directly to the top of a new or an existing fixture housing 50, such as via screws or other attachment means that secure the reflector 14 of the LED light module 10 to the housing 50. In other embodiments, the LED light module 10 is installed into a fixture housing 50 with the use of brackets 52, such as, but not limited to, those described in U.S. Pat. No. 8,220,957 (the entirety of which is herein incorporated by reference). See FIGS. 6 and 9. In such embodiments, the brackets 52 are mounted to the fixture housing 50 (such as via screws or other mechanical fasteners) and the LED light module 10 mounted to the brackets 52 (such as via screws or other mechanical fasteners). The brackets 52 can be of any geometry and are certainly not limited to those disclosed in the '957 Patent.

The LED light module 10 can be retro-fitted into an existing light fixture housing 50 without removal of the housing from the ceiling. Prior to installation, the existing light fixture 50 is stripped of its existing light sources (e.g., fluorescent tubes) and their associated wiring and electronics. See FIG. 9. The method of stripping the existing light fixture will vary depending upon the particular type of light sources, their associated hardware and electrical connections, and the configuration of the existing light fixture. Generally, the process for removal of the lighting elements from an existing light fixture will include: (i) removing electrical power from the existing light fixture housing; (ii) disconnecting any light sources and associated hardware from the existing light fixture; and (iii) removing unnecessary brackets or hardware, if any, from the housing. The housing 50 is then in a bare condition (except for incoming power wires 60) and ready to receive the LED light module 10. See FIG. 9.

The LED light module 10 is then installed in the housing 50, either by mounting it directly to the housing 50 or by first mounting brackets 52 to the housing 50 and then mounting the LED light module 10 to the brackets 52. During positioning of the LED light module 10 in the housing 50, the access door 42 may be open to permit positioning of the existing power wires 60 in the access door 42 opening. Once the LED light module 10 is supported in the housing 50, the necessary electrical connections are made between the existing power wires 60 and the LED light module electronics 40, after which the access door 42 is secured in a closed position (such as via screws, quarter turn fasteners, pins, or other mechanical fasteners 43).

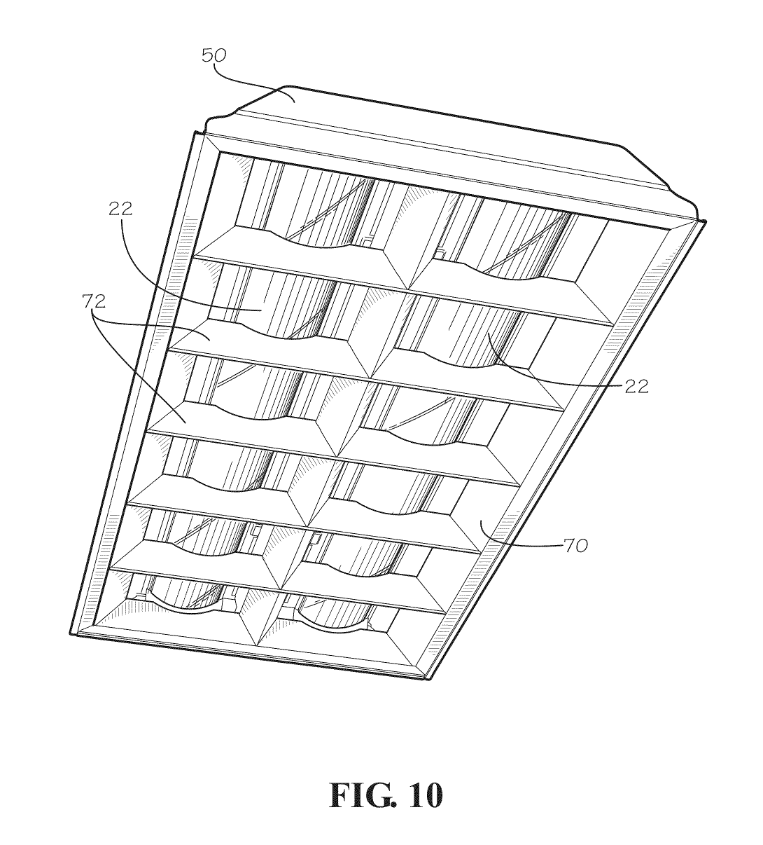

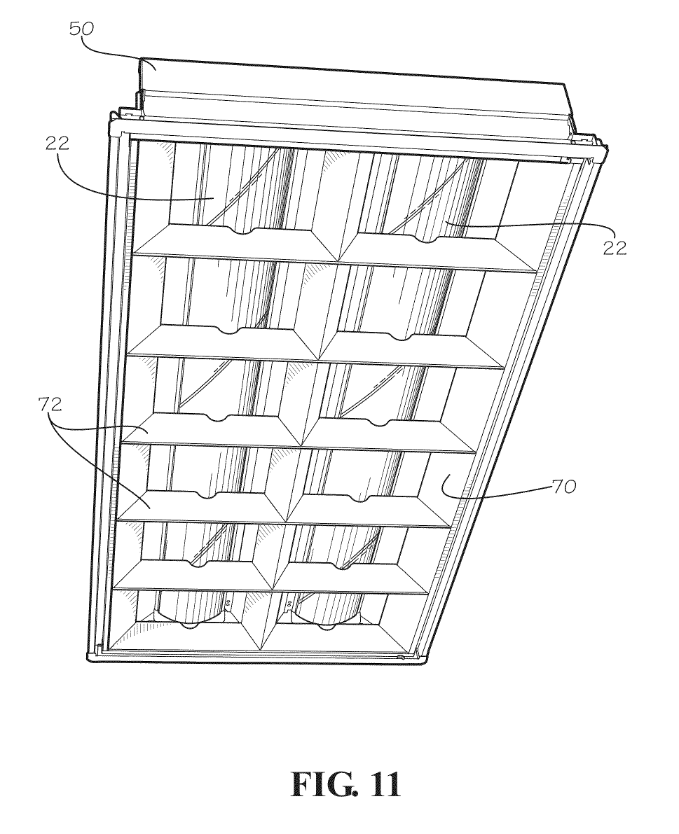

In some embodiments, the LED light module 10 is installed in louvered troffers (i.e., fixtures having louvers 70). In such embodiments, the geometry of the louver blades 72 of the louvers 70 can be designed to complement the geometry of the LED light module optic 22. For example, the contouring or profile provided on the top of the blades 72 can be designed to conform to the shape or profile of at least a portion of the optic 22. See FIG. 10. Alternatively, the geometry of the optic 22 can be designed to complement the geometry of the louver blades 72. For example, the bottom lobe 80 of a tri-lobe optic 22 (see FIG. 9) used on the LED light module 10 is similar in shape to a fluorescent tube and thus seats into the louver recesses 74 on louvers 70 from existing fluorescent louvered fixtures. Alternatively, there certainly is no requirement that the shape of the optic 22 on the LED light module 10 must correspond or complement the louver 70 geometry. Thus, an existing louver 70 can simply be re-used, regardless of the shape of the optic 22 on the LED light module 10. See FIG. 11.

Use of the LED light module 10 described herein can realize at least some of the following benefits:
Allows adoption of LED technology and benefits without removing an installed fixture from the ceiling grid.
Minimizes fixture disassembly and reconfiguration wiring during LED installation.
Provides “plug and play” field retrofit of higher efficiency LED components once they become available in the market.
Provides for volume production efficiencies of modular components that can easily be configured to fit various fixture layouts and designs.
Provides for faster production rates of new fixture assembly and retrofit installation.
Provides for a reduced rate of factory wiring errors.
Maintains an approved aesthetic by reusing existing luminaire louvers.
Provides a cost advantage over removal and replacement of an old installation with a new luminaire.

The foregoing is provided for purposes of illustrating, explaining, and describing embodiments of the present invention. Further modifications and adaptations to these embodiments will be apparent to those skilled in the art and may be made without departing from the scope or spirit of the invention. Different arrangements of the components depicted in the drawings or described above, as well as components and steps not shown or described are possible. Similarly, some features and subcombinations are useful and may be employed without reference to other features and subcombinations. Embodiments of the invention have been described for illustrative and not restrictive purposes, and alternative embodiments will become apparent to readers of this patent. Accordingly, the present invention is not limited to the embodiments described above or depicted in the drawings, and various embodiments and modifications can be made without departing from the scope of the invention.

We claim:

1. A lighting system comprising at least one LED light module, wherein the LED light module comprises:
(a) an LED assembly comprising:
a channel;
a plurality of light emitting diodes extending along the channel; and
an optic mounted on the channel and over the plurality of light emitting diodes; and
(b) a reflector comprising a base and angled reflective walls extending downwardly from opposing sides of the base,
wherein the LED assembly is mounted on the base of the reflector such that the angled reflective walls are positioned to reflect light emitted from the light emitting diodes.

2. The lighting system of claim 1, wherein the optic is mounted on the channel via snap-fit engagement.

3. The lighting system of claim 1, further comprising a fixture housing into which the LED light module is installed.

4. The lighting system of claim 1, further comprising at least two mounting brackets.

5. The lighting system of claim 4, further comprising a fixture housing, wherein the at least two mounting brackets are mounted on opposing ends of the fixture housing and wherein the LED light module is mounted to the at least two mounting brackets to retain the LED light module within the fixture housing.

6. The lighting system of claim 1, further comprising a louver formed of louver blades having a top surface, wherein the top surface of at least some of the louver blades comprise a profile substantially the same as the profile of at least a portion of the optic of the LED assembly.

7. The lighting system of claim 1, further comprising an access door having a first end, a second end, and a back surface onto which a driver is mounted, wherein the first end is hingedly attached to the reflector and wherein the second end is removably attached to the reflector.

8. The lighting system of claim 1, wherein the lighting system comprises at least two LED light modules.

9. The lighting system of claim 8, wherein the at least two LED light modules are oriented side by side.

10. The lighting system of claim 1, wherein the channel comprises end plates provided on opposing ends of the channel.

11. The lighting system of claim 10, wherein the end plates each comprise a reflective surface.

12. A method for installing a lighting system into an existing light fixture housing having an opening, the lighting system comprising:
(a) at least one LED light module comprising:
(i) an LED assembly comprising:
a channel;
a plurality of light emitting diodes extending along the channel; and
an optic mounted on the channel and over the plurality of light emitting diodes; and
(ii) a reflector comprising a base and angled reflective walls extending downwardly from opposing sides of the base,
wherein the LED assembly is mounted on the base of the reflector such that the angled reflective walls are positioned to reflect light emitted from the light emitting diodes; and
(b) at least two mounting brackets,
wherein the method comprises:
mounting the at least two mounting brackets on opposing ends of the existing light fixture housing;
positioning the at least one LED light module through the opening of the existing light fixture housing; and
mounting the at least one LED light module to the at least two mounting brackets.

13. The method of claim 12, wherein the at least one LED light module further comprises an access door having a first end, a second end, and a back surface onto which a driver is mounted, wherein the first end is hingedly attached to the reflector and wherein the second end is removably attached to the reflector, wherein the method further comprises opening the access door, connecting the driver to an electrical power source, and closing the access door.

14. The method of claim 12, further comprising positioning a louver at least partially over the opening of the existing light fixture housing.

15. The method of claim 14, wherein the louver comprises louver blades having a top surface, wherein the top surface of at least some of the louver blades comprises a profile substantially the same as the profile of at least a portion of the optic of the LED assembly.

16. A lighting system comprising:
(a) a light fixture housing;
(b) at least two mounting brackets mounted on opposing ends of the light fixture housing;
(c) at least one LED light module mounted to the at least two brackets, the at least one LED light module comprising:
(i) an LED assembly comprising:
a channel comprising side arms providing along opposing sides of the channel and end plates provided on opposing ends of the channel;
a plurality of light emitting diodes extending along the channel; and
an optic snap-fitted onto the side arms of the channel so as to be positioned over the plurality of light emitting diodes; and
(ii) a reflector comprising:
a base; and
angled reflective walls extending downwardly from opposing sides of the base,
wherein the LED assembly is mounted on the base of the reflector such that the angled reflective walls are positioned to reflect light emitted from the light emitting diodes; and
(iii) an access door having a first end, a second end, and a back surface onto which a driver is mounted, wherein the first end is hingedly attached to the reflector and wherein the second end is removably attached to the reflector; and
(d) a louver formed of louver blades having a top surface, wherein the top surface of at least some of the louver blades comprise a profile substantially the same as the profile of at least a portion of the optic of the LED assembly.
